(19) United States
(12) Patent Application Publication
(10) Pub. No.: US 2026/0217988 A1
(43) Pub. Date: Jul. 30, 2026

(54) COATING COMPOSITION, METHOD FOR FORMING A COATING AND USE

(71) Applicant: INNOMOST OY, Kokkola (FI)

(72) Inventor: Sami SELKÄLÄ, Kokkola (FI)

(21) Appl. No.: 19/145,169

(22) PCT Filed: Jan. 9, 2024
(86) PCT No.: PCT/FI2024/050006

§ 371 Date: Jul. 1, 2025

(30) Foreign Application Priority Data
Jan. 9, 2023 (FI) 20235025

(51) Int. Cl. C09D 5/16; C09D 7/63; C09D 15/00; D06M 13/207; D06M 101/06; D21H 19/12; D21H 21/16

(52) U.S. Cl. CPC C09D 5/1662; C09D 7/63; C09D 15/00; D06M 13/207; D21H 19/12; D21H 21/16; D06M 2101/06; D06M 2200/12

(57) ABSTRACT

The application relates to a coating composition. The coating composition comprises ω-hydroxy fatty acids and water. Furthermore, a method for forming a coating and use related thereto are described.

### FIELD

The present disclosure relates to a coating composition as defined in claim 1 and to a method for forming a coating as defined in claim 4, as well as to use of the coating composition as defined in claim 12 and to use of the method as defined in claim 13.

### BACKGROUND

Birch (Betula spp.) is widespread throughout the Northern Hemisphere and harvested in huge volumes. Birch bark is produced in considerable quantities as a byproduct of the forest industry and its upgrading is almost totally neglected. Currently, this low-value side stream is burnt for combined heat and power production.

It has been estimated that a pulp mill with an annual production capacity of 200,000 tonnes of birch kraft pulp produces enough bark to produce around 2,500 tonnes of betulin of around 95% purity and 4,000 tonnes of suberin acids per annum. Suberin polyester can be hydrolyzed by base treatment to multifunctional suberin acids, which are potential raw materials for paints, adhesives, lubricants and surface-active agents.

### SUMMARY

The coating composition comprises ω-hydroxy fatty acids and water.

In the method for a coating, the coating composition is applied onto a surface to form a covered surface by means of heat.

### DETAILED DESCRIPTION

The coating composition comprises ω-hydroxy fatty acids and water.

In one embodiment, the coating composition contains ω-hydroxy fatty acids in an amount of 5-99.9 weight-% and water in an amount of 0.1-95 weight-%. In one embodiment, the coating composition contains ω-hydroxy fatty acids in an amount of 5-15 weight-%, in one embodiment 5-13 weight-%, and water in an amount of 85-95 weight-%, in one embodiment 87-95 weight-%. In one embodiment, the coating composition is a dry composition or a dried composition, and the composition comprises only little water. In one embodiment, the coating composition comprises or consists of ω-hydroxy fatty acids in an amount of 5-99.9 weight-% based on the total weight of the coating composition and water in an amount of 0.1-95 weight-% based on the total weight of the coating composition. In one embodiment, the coating composition comprises or consists of ω-hydroxy fatty acids in an amount of 5-15 weight-% based on the total weight of the coating composition, in one embodiment 5-13 weight-% based on the total weight of the coating composition, and water in an amount of 85-95 weight-% based on the total weight of the coating composition, in one embodiment 87-95 weight-% based on the total weight of the coating composition.

In one embodiment, the composition of the ω-hydroxy fatty acids comprises 18-hydroxyoctadec-9-enoic acid, 16,9-dihydroxyhexadecanoic acid, 9,10-epoxy-18-hydroxyoctadecanoic acid, 20-hydroxyeicosanoic acid, 9,10,18-trihydroxyoctadecanoic acid and/or 22-hydroxydocosanoic acid. In one embodiment, the composition of the ω-hydroxy fatty acids is presented as following:

18-hydroxyoctadec-9-enoic acid, 298.45 g/mol, 0-5 GC area-%, 16,9-dihydroxyhexadecanoic acid, 288.42 g/mol, 0-2 GC area-%, 9,10-epoxy-18-hydroxyoctadecanoic acid, 314.45 g/mol, 70-85 area-%, 20-hydroxyeicosanoic acid, 328.52 g/mol, 0-3 area-%, 9,10,18-trihydroxyoctadecanoic acid, 332.47 g/mol, 0-10 area-%, and 22-hydroxydocosanoic acid, 356.57 g/mol, 5-15 area-%. In one embodiment, the composition of the ω-hydroxy fatty acids is presented as following: 18-hydroxyoctadec-9-enoic acid, 298.45 g/mol, 0-15 weight-%, 16,9-dihydroxyhexadecanoic acid, 288.42 g/mol, 0-2 weight-%, 9,10-epoxy-18-hydroxyoctadecanoic acid, 314.45 g/mol, 50-65 weight-%, 20-hydroxyeicosanoic acid, 328.52 g/mol, 0-3 weight-%, 9,10,18-trihydroxyoctadecanoic acid, 332.47 g/mol, 0-15 weight-%, and 22-hydroxydocosanoic acid, 356.57 g/mol, 5-15 weight-%.

In one embodiment, the composition of the ω-hydroxy fatty acids is presented as following: 18-Hydroxyoctadec-9-enoic acid, 0-2 weight-%

16,9-dihydroxyhexadecanoic acid, 288.42 g/mol, 0-2 weight-% 9,10-Epoxy-18-hydroxyoctadecanoic acid, 70-85 weight-% 20-Hydroxyeicosanoic acid, 1-5 weight-% 9,10,18-Trihydroxyoctadecanoic acid, 0-5 weight-% 22-Hydroxydocosanoic acid, 10-25 weight-%. In one embodiment, the composition of the ω-hydroxy fatty acids is presented as following: 18-Hydroxyoctadec-9-enoic acid, 0.1-2 weight-% 16,9-dihydroxyhexadecanoic acid, 288.42 g/mol, 0.1-2 weight-% 9,10-Epoxy-18-hydroxyoctadecanoic acid, 70-85 weight-% 20-Hydroxyeicosanoic acid, 1-5 weight-% 9,10,18-Trihydroxyoctadecanoic acid, 0.1-5 weight-% 22-Hydroxydocosanoic acid, 10-25 weight-%.

The inventors surprisingly found out that when the coating composition has 9,10-Epoxy-18-hydroxyoctadecanoic acid in an amount of 50-85 weight-% based on the total weight of the ω-hydroxy fatty acids, the ω-hydroxy fatty acids are more reactive. In one embodiment, ω-hydroxy fatty acids comprise 9,10-Epoxy-18-hydroxyoctadecanoic acid in an amount of 50-85 weight-%, or 70-85 weight-%, or 50-65 weight-% based on the total weight of the ω-hydroxy fatty acids.

In one embodiment, the ω-hydroxy fatty acids have the purity of 85%-99.9 weight-%, or 95-98 weight-%, or 96-97 weight-%, or 92-94 weight-%. The weight percentage (weight-%) purity of the ω-hydroxy fatty acids may be determined by gas chromatography (GC), which calculates purity of a substance, such as ω-hydroxy fatty acids, based on the amount of the main component peak area compared to the total peak areas. The impurities of ω-hydroxy fatty acids may have an effect on the hydrophobicity. The impurities may include e.g. betulin. More homogenous barriers can be formed when betulin is removed from the product.

In one embodiment, the coating composition comprises less than 1 weight-% betulin, in one embodiment less than 0.5 weight-% betulin, in one embodiment less than 0.15 weight-% betulin and in one embodiment less than 0.1 weight-% betulin.

In the method for a coating, the coating composition is applied onto a surface to form a covered surface, i.e. the coating, by means of heat, i.e. by utilizing or using heat. In one embodiment, the method comprises applying the coating composition onto a surface and heat treating the surface to form a coating.

In this context, the surface means any surface, e.g. the surface of material, plate, sheet, object, device or the like. The surface can be formed from any material. In one embodiment, the surface is formed from skin, leather, wood, paper, cardboard, textile, leather, metal, brick, plastic, e.g. bio-based plastic, food material, fiber material or the like.

In one embodiment, the coating composition is applied onto the surface as a suspension, such as water wet suspension, or as a dried material onto the surface. In one embodiment, the coating composition is applied onto the surface as a melt mixture. In one embodiment, the coating composition is applied onto the surface by spraying.

In one embodiment, the coating composition is applied onto a surface to form a covered surface and the covered surface is heated, such as heat treated. In one embodiment, the coating composition is applied onto a surface and the surface is heat treated to form the covered surface, i.e. coating. In one embodiment, the covered surface is treated with a heated air flow.

In one embodiment, the covered surface is formed at a temperature range of 20-150° C. In one embodiment, the covered surface is treated at a temperature range of 20-150° C. In one embodiment, the temperature range of less than 100° C., e.g. 20-100° C., is used. In one embodiment, the temperature range of more than 100° C. or more than 110° C., e. g. 100-150° C., is used. When the temperature range of more than 100° C. is used, ω-hydroxy fatty acids start to polymerize, and then a partially crosslinked polymeric coating can be formed. The inventors surprisingly found out that the ω-hydroxy fatty acids do not need to be polymerized to form a hydrophobic coating on a surface. Hydrophobic nature of ω-hydroxy fatty acids and spreading of mono, di- and partially polymerized ω-hydroxy fatty acids on a surface form coating on a surface. Thus, the covered surface may be treated at a temperature range of 20-150° C.

In one embodiment, the thickness of the formed coating is 0.0001-3 mm. In one embodiment, the thickness of the formed coating may be 0.01-2 mm, or 0.1-1 mm, or 0.5-1 mm. The thickness of the formed coating can vary, e.g. depending on an applying method of the coating composition, a concentration of the coating composition, an amount of the coating composition on a surface or an amount of coating layers on a surface.

In one embodiment, the coating composition and especially the ω-hydroxy fatty acids are formed from a bark powder, e.g. betulin extracted bark powder. In one embodiment, the bark powder is formed from birch bark. The bark powder, e.g. betulin extracted bark powder, can be formed in any suitable way.

In one embodiment, the bark powder is formed by means of the method which comprises: providing a raw material comprising birch bark, screening the raw material comprising birch bark to remove fines to form a screened raw material, separating the screened raw material into a fraction comprising inner bark and wood particles, and a fraction comprising outer bark, drying the fraction comprising outer bark to form dried bark, cutting the dried bark in a cutting mill to form cut bark, screening the cut bark to remove fines and form a fraction comprising bark, milling the fraction comprising bark in a cutting milling to form a bark powder.

In one embodiment, the bark powder may be subjected to extractions and other chemical treatments to obtain chemical compounds and products for further use. In one embodiment, the bark powder is subjected to a liquid-solid extraction to recover soluble components from the bark powder. Various chemical compounds may be extracted from the bark powder, such as from birch bark powder, directly using the liquid-solid extraction using a suitable solvent. The solvent and the extraction process may be selected according to the compound to be extracted.

In one embodiment, betulin and ω-hydroxy fatty acids are separated from the bark powder.

In one embodiment, extracting betulin from the bark powder comprises extracting the bark powder with an organic solvent, e.g. isopropanol, under reflux conditions followed by isolation of the betulin by consecutive decantation and reslurrying steps. After removal of excess solvent, betulin may be collected and/or recovered.

In one embodiment, the bark powder or the betulin extracted bark powder is subjected to a liquid-solid extraction to recover suberin and/or ω-hydroxy fatty acids from the bark powder. In one embodiment, ω-hydroxy fatty acids, preferably desired ω-hydroxy fatty acids, are separated from a suberin composition. Suberin means a lipophilic macromolecule. The suberin is a complex polyester which is composed of poly-functional long chain fatty acids (suberin acids) and glycerol.

In one embodiment, ω-hydroxy fatty acids are recovered from the bark powder using a liquid-solid extraction. Any suitable solvent can be used. In one embodiment, the solvent is an alcohol or a mixture comprising an alcohol. In one embodiment, the solvent is isopropanol or a mixture comprising an isopropanol.

In one embodiment, the betulin extracted bark powder is dried, e. g. in an atmospheric or vacuum conditions. In one embodiment, a solvent is recycled back to an extraction step.

In one embodiment, a mixture comprising isopropanol or other alcohol is formed, and in one embodiment a resulting mixture is treated, e.g. by stirring, heating and/or by reflux. In one embodiment, the resulting mixture is mixed with the betulin extracted birch bark. In one embodiment, the resulting mixture is stirred and heated to reflux. In one embodiment, a liquid phase is separated by decantation, and after decantation, a solid phase is a mixture with the alcohol, e.g. isopropanol. In one embodiment, a formed mixture is heated to reflux conditions. In one embodiment, the formed mixture is cooled, and a liquid phase is separated from the solvent wet solid phase by decantation.

In one embodiment, the extracted residual solid phase is dried, e.g. by an atmospheric or vacuum distillation. In one embodiment, a solvent is recycled to an extraction phase.

In one embodiment, separated liquid phases are cooled, and formed solids, e.g. salt crystals, are separated by decantation. In one embodiment, the separated solids, e.g. salt, is dried by an atmospheric or vacuum distillation. In one embodiment, a solvent is recycled to an extraction phase.

In one embodiment, a toluene solution is formed. In one embodiment, water is preheated and toluene is added. In one embodiment, a formed solution is heated, and the separated solids, e.g. salt, is added and a resulting mixture is stirred. In one embodiment, water phase and immiscible organic phase are separated by decantation. In one embodiment, the water phase is cooled, and acid solution, e.g. sulfuric acid water solution, is added until pH is suitable. In one embodiment, a formed solid is separated by decantation. Then a water wet solid suspension containing ω-hydroxy fatty acids can be formed. In one embodiment, the solid phase is washed with water until pH is above 4. In one embodiment, a product is an emulsion like mixture of ω-hydroxy fatty acids in water.

In one embodiment, the betulin extracted bark powder is dried in an atmospheric or vacuum conditions to recycle an extraction solvent back to an extraction step and bark mass is obtained, where solvent content is less than 50%. Typically, solvent content is 0-10 weight-%. Isopropanol, or alternatively any alcohol, is mixed with sodium hydroxide and the resulting mixture is stirred and heated to reflux conditions, e.g. for 30-70 minutes, in one embodiment for 60 minutes. The resulting mixture is mixed with the betulin extracted birch bark. The resulting mixture is stirred and heated to reflux, e.g. for 70-100 minutes, in one embodiment for 90 minutes. The liquid phase is separated by decantation. After decantation, the solid phase is a mixture with isopropanol. The resulting mixture is heated to reflux conditions, e.g. for 20-40 minutes, in one embodiment for 30 minutes. The mixture is cooled, e.g. to 70-90° C., in one embodiment to 80° C., and liquid phase is separated from the solvent wet solid phase by decantation. The extracted residual solid phase is dried by an atmospheric or vacuum distillation to recycle the solvent to an extraction phase. The separated liquid phases are cooled, e. g. to 10-15° C., in one embodiment to 12° C., and the formed solids, e.g. NaFSA salt crystals, are separated by decantation. The separated solid, NaFSA salt, is dried by an atmospheric or vacuum distillation to recycle the solvent to extraction phase. Water is preheated, e.g. to 70-90° C., in one embodiment to 80° C., and toluene is added. Alternatively, toluene is not added if all betulin removed beforehand. The resulting mixture is heated, e.g. to 70-90° C., in one embodiment to 80° C. NaFSA salt is added and the resulting mixture is stirred, e.g. for 3-7 minutes, in one embodiment for 5 minutes. The resulting lower water phase and immiscible organic phase are separated by decantation. The water phase is cooled, e.g. to 30-40° C., in one embodiment to 35° C., and sulfuric acid water solution, e.g. 30 weight-% sulfuric acid water solution, is added until pH is about 2.0. The formed solid is separated by decantation. A water wet solid suspension containing ω-hydroxy fatty acids is formed. The solid phase is washed with water until pH is above 4. The resulting water wet product is practically betulin free. The dry weight content of the formed suspension is typically 10-25 weight-%. The product is an emulsion like mixture of ω-hydroxy fatty acids in water. Thus, a product containing ω-hydroxy fatty acids is formed.

In one embodiment, the ω-hydroxy fatty acids are dried. In one embodiment, the ω-hydroxy fatty acids are dried under air flow at an atmospheric pressure, preferably below melting point between 20-60° C., or in vacuum conditions, preferably below 60° C.

In one embodiment, the bark powder can be treated and a suberin product containing ω-hydroxy fatty acids can be formed according to example 6. The suberin product can be further treated for recovering ω-hydroxy fatty acids.

In one embodiment, betulin is removed from the product containing ω-hydroxy fatty acids. In one embodiment, the product comprises less than 5 weight-% betulin, in one embodiment less than 3 weight-% betulin, and in one embodiment less than 1 weight-% betulin. Betulin has lower solubility and has a crystal structure compared to ω-hydroxy fatty acids. More homogenous barriers can be formed when betulin is removed from the product.

In one embodiment, the mixture of the ω-hydroxy fatty acids is treated by a toluene treatment. In one embodiment, the product containing the ω-hydroxy fatty acids comprises less than 1 weight-% betulin, in one embodiment less than 0.5 weight-% betulin, in one embodiment less than 0.15 weight-% betulin and in one embodiment less than 0.1 weight-% betulin, after the toluene treatment.

In one embodiment, the composition of the ω-hydroxy fatty acids may comprise: 18-hydroxyoctadec-9-enoic acid, 298.45 g/mol, 0-5 weight-%, 16,9-dihydroxyhexadecanoic acid, 288.42 g/mol, 0-2 weight-%, 9,10-epoxy-18-hydroxyoctadecanoic acid, 314.45 g/mol, 70-85 weight-%, 20-hydroxyeicosanoic acid, 328.52 g/mol, 0-3 weight-%, 9,10,18-trihydroxyoctadecanoic acid, 332.47 g/mol, 0-10 weight-%, and 22-hydroxydocosanoic acid, 356.57 g/mol, 5-15 weight-%.

The composition for the coating can be formed from the product containing ω-hydroxy fatty acids. The resulting product containing ω-hydroxy fatty acids can be used as a water wet suspension or a dried material to make a hydrophobic barrier on top of different materials. For example, packing materials such as paper and cardboard can be covered with the resulting composition of the ω-hydroxy fatty acids by applying the water wet suspension onto the surface of the material and drying the covered surface. Also, woven or nonwoven materials made for example from cotton and other cellulosic materials such as wood fibers can be treated with the resulting composition of the ω-hydroxy fatty acids.

The coating composition can be used in the treatment of wood, wooden board, paper, packaging material, cardboard, textiles, leather, skin, artificial leather, yarn, metals, metal plates, automotive parts, woven material, nonwoven material, wood fibers, construction materials, plywoods, veneers, concrete, geopolymer casting products, block, brick, plasterboard, insulation board, pharmaceutical products, medicinal tablets, food products, e.g. cheese, candy, food supplement tablets or dry pet food products, fiber based household products, or cutlery, e.g. knife, fork, spoon, straw, plate or cup. The method can be used in the treatment of wood, wooden board, paper, packaging material, cardboard, textiles, leather, skin, artificial leather, yarn, metals, metal plates, automotive parts, woven material, nonwoven material, wood fibers, construction materials, plywoods, veneers, concrete, geopolymer casting products, block, brick, plasterboard, insulation board, pharmaceutical products, medicinal tablets, food products, e.g. cheese, candy, food supplement tablets or dry pet food products, fiber based household products, or cutlery, e. g. knife, fork, spoon, straw, plate or cup.

The coating described in the current specification has many advantages. The coating is hydrophobic, and it can be used as a water hydrophobic barrier and corrosion protection. Thanks to the coating, more homogenous barriers can be formed when betulin is removed from the composition. When betulin is removed from the composition, crystals of betulin do not appear as an inhomogeneity in the coating. Further, by means of the coating can be achieved an increased paper tear strength.

The coating can be arranged easily onto a desired surface, i.e. it is a very simple method. The coating can be used for various materials. Further, the coating is a bio-based coating.

### EXAMPLES

Reference will now be made in detail to the described embodiments. The description below discloses some embodiments in such a detail that a person skilled in the art is able to form and utilize the coating based on the disclosure. Not all steps of the embodiments are discussed in detail, as many of the steps will be obvious for the person skilled in the art based on this specification.

### Example 1—Application of ω-Hydroxy Fatty Acids to Nonwoven Material

Water emulsion containing a 13 weight-% of ω-hydroxy fatty acids was applied, 1 g, on top of a paper, 3×3 cm area. The water was evaporated from the surface with a heated air flow. When the temperature of the surface was kept below 100° C., a thin layer, 0.001-2 mm, from the composition of the ω-hydroxy fatty acids was formed as barrier on top of the paper. When the temperature was increased above 110° C., the ω-hydroxy fatty acids started to melt and partially polymerize and the result was a partially crosslinked polymeric barrier. The polymerization could be continued at 120-150° C. to form crosslinked polymer on top of the paper.

The formed barrier area of the paper was treated with water spray. The ω-hydroxy fatty acids treated area of the paper was hydrophobic and the untreated side of the paper was completely dry. Untreated paper surface was very hydrophilic and became soft and fragile after water contact. The treated paper area of the paper had increased tear strength compared to the original paper.

### Example 2—Application of ω-Hydroxy Fatty Acids to Woven Material

A water emulsion, 5 g, containing a 5 weight-% of ω-hydroxy fatty acids, was spread evenly on top of cotton textile, 3×3 cm. The water was evaporated from the surface with a heated air flow. When the temperature of the surface was kept below 100° C., a thin layer, 0.001-1 mm, from the composition of ω-hydroxy fatty acids was formed as barrier on top of the textile material. When the temperature was increased above 110° C., the ω-hydroxy fatty acids started to polymerize and the result was a partially crosslinked polymeric barrier.

The treated textile material was treated with a water spray, and it was noticed that the treated area had hydrophobic surface compared to untreated textile area.

### Example 3—Application of ω-Hydroxy Fatty Acids to Metal Material

A dried mixture of ω-hydroxy fatty acid composition was melted at 90° C. A stainless steel pipe, diameter 3 cm was treated with the formed melt to form a layer on top of the steel pipe. A layer, 0.001-2 mm, was formed on top of the steel pipe. The layer was allowed to cool to room temperature.

The treated steel pipe was treated with water. It was noticed that the formed layer of ω-hydroxy fatty acids was hydrophobic on the top of the steel pipe. It was obtained that the resulting layer can be used as water hydrophobic barrier and corrosion protection on the surface of the steel pipe. Additional adhesion additive was not required. A result was a very simple method to make water protection on top of a steel material.

Alternatively, the surface can be prepared similarly by using spray of water emulsion containing a 1-13 weight-%, preferably 5-13 weight-%, of ω-hydroxy fatty acids.

### Example 4. Application of ω-Hydroxy Fatty Acids to Wood Panel

A water emulsion, 5 g, containing a 13 weight-% of ω-hydroxy fatty acids, was spread evenly as a thin layer with a help of metal pipe on top of thin birch veneer plate, 10×15 cm. The water was evaporated from the surface with a heated air flow. When the temperature of the surface was kept below 100° C., a thin layer, 0.001-1 mm, from the composition of ω-hydroxy fatty acids was formed as barrier on top of the birch veneer material. The surface was matte and was white to yellow in color. The treated surface was polished below 100° C. by using cotton fabric. The surface was nearly colorless and glossy after polishing.

The treated birch veneer plate was treated with a water spray, and it was noticed that the treated area had hydrophobic surface compared to untreated birch veneer plate.

### Example 5—Formation of ω-Hydroxy Fatty Acids

The betulin extracted bark powder was dried in an atmospheric or vacuum conditions to recycle an extraction solvent back to an extraction step and bark mass was obtained, where solvent content was less than 50%. Typically, solvent content is 0-10 weight-%.

Isopropanol 7500 g, or alternatively any alcohol, was mixed with sodium hydroxide 253 g and the resulting mixture was stirred and heated to reflux conditions for 60 minutes.

The resulting mixture was mixed with a 1000 g of the betulin extracted birch bark. The resulting mixture was stirred and heated to reflux for 90 minutes. The liquid phase was separated by decantation. After decantation, the solid phase was a mixture with isopropanol 4000 g. The resulting mixture was heated to reflux conditions for 30 minutes. The mixture was cooled to 80° C. and liquid phase was separated from the solvent wet solid phase by decantation. The extracted residual solid phase was dried by an atmospheric or vacuum distillation to recycle the solvent to an extraction phase.

The separated liquid phases were cooled to 12° C. and the formed solids (NaFSA salt crystals) were separated by decantation. The separated solid (NaFSA salt) was dried by an atmospheric or vacuum distillation to recycle the solvent to extraction phase.

Water 6000 g was preheated to 80° C. and toluene 1000 g was added. Alternatively, toluene may not be added if all betulin is removed beforehand. The resulting mixture was heated to 80° C. NaFSA salt was added and the resulting mixture was stirred for 5 minutes. The resulting lower water phase and immiscible organic phase were separated by decantation. The water phase was cooled to 35° C. and 30 weight-% sulfuric acid water solution was added until pH was 2.0. The formed solid was separated by decantation. A water wet solid suspension containing ω-hydroxy fatty acids was formed. The solid phase was washed with water until pH was above 4. The resulting water wet product was practically betulin free. The dry weight content of the formed suspension is typically 10-25 weight-%. The product was an emulsion like mixture of ω-hydroxy fatty acids in water.

Typically, the composition of the ω-hydroxy fatty acids can comprises: 18-hydroxyoctadec-9-enoic acid, 298.45 g/mol, 0-5 GC area-%, 16,9-dihydroxyhexadecanoic acid, 288.42 g/mol, 0-2 GC area-%, 9,10-epoxy-18-hydroxyoctadecanoic acid, 314.45 g/mol, 70-85 area-%, 20-hydroxyeicosanoic acid, 328.52 g/mol, 0-3 area-%, 9,10,18-trihydroxyoctadecanoic acid, 332.47 g/mol, 0-10 area-%, and 22-hydroxydocosanoic acid, 356.57 g/mol, 5-15 area-%.

The product comprising ω-hydroxy fatty acids can be dried under air flow at an atmospheric pressure, preferably below melting point between 20-60° C., or in vacuum conditions, preferably below 60° C.

### Example 6—Extraction of Suberin

7.5 kg (5.9 l) of isopropanol was loaded in a reactor and 0.253 kg of NaOH was added. The mixture was heated and allowed to reflux for 60 min to allow all NaOH to dissolve in the isopropanol before allowing the mixture to cool to approximately 80° C.

Approximately 3.5 kg of wet birch bark powder was added to the isopropanol solution and the mixture refluxed for 1.5 h while stirring before allowing the mixture to cool to about 80° C. After cooling, the formed suspension was centrifuged, and the liquid phase separated from the solid cake carefully.

The wet cake was moved to a reactor and 4.0 kg (3.14 l) of isopropanol was added. The formed mixture was refluxed for 30 min while stirring and allowed to cool to approximately 80° C. After cooling, the formed suspension was centrifuged, and the liquid phase separated from the solid cake carefully.

The combined liquid phases from both extractions were slowly cooled to 13° C. overnight.

The cooled suspension of suberin sodium salt was centrifuged and the solid cake collected. The wet suberin sodium salt was dried at 35° C. until all isopropanol had evaporated.

The dried suberin sodium salt was suspended in 6 kg (6 l) of deionized water heated to 80° C. and 30% aqueous sulphuric acid added dropwise to the suspension until the pH is 2.0. The solution was stirred for 15 min to ensure that the pH was stable.

After acidifying, the suberin solution was centrifuged at 3500 rpm. The aqueous phase on top was removed and the lower emulsion phase collected.

The emulsion phase was washed four times with deionized water to produce an emulsion with a pH of over 4.3.

After acidifying, the suberin solution was centrifuged at 3500 rpm. The aqueous phase on top was removed and the lower emulsion phase collected.

The emulsion phase was washed four times with deionized water to produce an emulsion with a pH of over 4.3.

The emulsion was dried at 65° C. and reduced pressure to yield suberin with a purity of approximately 60% of 9,10-epoxy-18-hydroxyoctadecanoic acid.

### Example 7—Application of ω-Hydroxy Fatty Acids to Wood Panel

A water emulsion, 5 g, containing a 13 weight-% of ω-hydroxy fatty acids, was spread evenly as a thin layer with a help of metal pipe on top of thin birch veneer plate, 10×15 cm. The water was evaporated at 20° C. from the surface with an air flow. A thin layer, 0.001-1 mm, from the composition of ω-hydroxy fatty acids was formed as barrier on top of the birch veneer material. The surface was matte and was white to yellow in color. The treated surface was polished at 20° C. by using cotton fabric. The surface was nearly colorless and glossy after polishing.

The treated birch veneer plate was treated with a water spray, and it was noticed that the treated area had hydrophobic surface compared to untreated birch veneer plate.

It is obvious to a person skilled in the art that with the advancement of technology, the basic idea of the invention may be implemented in various ways. The invention and its embodiments are thus not limited to the examples described above, instead they may vary within the scope of the claims.

1. A coating composition comprising ω-hydroxy fatty acids and water.

2. The coating composition of claim 1, wherein the coating composition contains ω-hydroxy fatty acids in an amount of 5-99.9 weight-% and water in an amount of 0.1-95 weight-%.

3. The coating composition of claim 1, wherein the coating composition comprises less than 0.5 weight-% betulin.

4. A method for forming a coating, wherein the method comprises applying the coating composition of claim 1 onto a surface to form a covered surface by means of heat.

5. The method of claim 4, wherein the coating composition is applied onto the surface as a suspension or as a dried material.

6. The method of claim 4, wherein the coating composition is applied onto the surface as a melt mixture.

7. The method of claim 4, wherein the coating composition is applied onto the surface by spraying.

8. The method of claim 4, wherein the coating composition is applied onto a surface to form a covered surface and the covered surface is heated.

9. The method of claim 4, wherein the covered surface is treated with a heated air flow.

10. The method of claim 4, wherein the covered surface is treated at a temperature range of 20-150° C.

11. The method of claim 4, wherein the thickness of the formed coating is 0.0001-3 mm.

12. Use of the coating composition according to claim 1, wherein the coating composition is used in the treatment of wood, wooden board, paper, packaging material, cardboard, textiles, leather, artificial leather, skin, yarn, metals, metal plates, automotive parts, woven material, nonwoven material, wood fibers, construction materials, plywoods, veneers, concrete, geopolymer casting products, block, brick, plasterboard, insulation board, pharmaceutical products, medicinal tablets, food products, fiber based household products, or cutlery.

13. Use of the method according to claim 4, wherein the method is used in the treatment of wood, wooden board, paper, packaging material, cardboard, textiles, leather, skin, artificial leather, yarn, metals, metal plates, automotive parts, woven material, nonwoven material, wood fibers, construction materials, plywoods, veneers, concrete, geopolymer casting products, block, brick, plasterboard, insulation board, pharmaceutical products, medicinal tablets, food products, fiber based household products, or cutlery.
